(19) United States
(12) Patent Application Publication
(10) Pub. No.: US 2012/0091385 A1
(43) Pub. Date: Apr. 19, 2012

(54) PROCESS VALVE HAVING A FLEXIBLE SEALING EDGE

(75) Inventor: EUGEN NEBEL, NIDDERAU-WINDECKEN (DE)

(73) Assignee: SAMSON AG, FRANKFURT AM MAIN (DE)

(21) Appl. No.: 13/101,133

(22) Filed: May 4, 2011

(30) Foreign Application Priority Data
May 7, 2010 (DE) 102010016845.9-12

(51) Int. Cl. F16K 25/00

(52) U.S. Cl. 251/359

(57) ABSTRACT

Process valve for controlling and shutting off a fluid stream comprising a valve seat (10, 30) for receiving a movable valve body (14, 32) in a through hole (12, 36), the valve seat (10, 30) and the valve body (14, 32) are adapted to be pressed into and onto a sealing edge (18, 38) in order to prevent a fluid stream through the process valve. A circumferential groove (20, 36) resides in the valve seat and a flexible sealing lip (26, 44) is formed between the groove (20, 36) and the sealing edge (18, 38). The geometry of the groove (20, 36) is formed such that the side surface (22, 40) closer the sealing edge (18, 38) of the groove (20, 36) is arranged such that the size of the sealing lip (26, 44) increases with increasing depth of the groove (20, 36).

The invention relates to a process valve having a flexible sealing edge at the valve seat.

Process valves are used for controlling material streams in plants of the chemical industry, of the mineral oil chemistry, in power plants and in other areas. They usually have a housing in which there are a fixedly clamped or a screwed-in valve seat and a movably supported valve body or stop body. The valve body is, as a rule, guided by a valve rod. The material stream is defined and controlled by means of the distance of the valve body from the valve seat.

Besides a control function, process valves, in certain operational modes, have to he able to permanently stop the flow-through. In spite of this, it is not possible according to the state of the art to achieve a completely leakage free sealing-off process valve. In principal, the leakage is proportional to the pressure of the fluid stream to be closed of.

For reducing leakage, primarily, soft elastic seals are used which are inserted in the transition between the valve seat and the valve body. This measure has the disadvantage that it is not suited for aggressive materials since aggressive materials dissolve the materials of the soft seal and thereby, on the one hand, destroy the seal and, on the other hand, contaminate the material stream the dissolved seal materials.

From WO 2009/033843 A1 it is known that the leakage in a check valve the valve seat of which comprises a through hole, can be reduced by an elastic, circumferential sealing lip. This sealing lip is produced in particular thereby that a ring groove being concentric to the through hole and having a rectangular cross section, is inserted into the valve seat. According to the teaching of the WO 2009/033843 A1, the elastic circumferential sealing lip meets the elevated leakage requirements at lower system pressures. In the case of the non-return valve, the system pressure also has an effect of a lower contacted pressure of the valve body onto the sealing lip of the valve seat.

It is a problem of this arrangement that, because of a weakening of the material for producing the elasticity of the sealing lip, the weakened material can easily be damaged at high contact pressures of the valve body or is getting rapidly fatigued at high closing frequencies of the valve and can, therefore, not fulfil anymore its sealing function.

The object of the invention is to provide a process valve that has exquisitely low leakage and can be easily manufactured.

In a known manner, the valve seat of the process valve comprises a through hole which is adapted to be closed if required by a valve body. In order to cut off the volume stream, the valve body is pressed into the valve seat: The line of contact between the valve body and the valve seat forms a sealing edge. In a known manner, the sealing edge can be formed flexibly thereby that, at a distance from the sealing edge, a groove is inserted which forms a sealing flap between the groove and the sealing edge.

In a surprising way, it is achieved that, by means of corresponding geometry of the groove, a configuration can be obtained which, on the one hand, provides a defined elasticity of the sealing lip and, on the other hand, can take up also high contact pressures of the valve body of a process valve. The geometry to be used depends on the ductility of the material.

According to the invention, at least one side surface of the groove, which is located closer to the sealing edge, is tapered such that surfaces of the same tension are present in that the size of the sealing lip increases with increasing depth. The tension forces which can be encountered by the pressing of the valve body into the valve seat, are distributed by means of this geometry in an equal manner across the total side surface of the groove whereby peak stresses at individual positions are avoided.

The force distribution achieved thereby makes it possible to reduce the leakage by a turned down portion of the sealing lip and, in spite of the high requirements and contact pressure of a process valve, ensures the functionality of the process valve in a permanent and reliable way.

Contrary to this, a mere enlargement of the total size of the sealing lip which, for example, means a larger distance of the groove from the through hole, would result in a reduction of the elasticity of the sealing lip and, thereby, poorer leakage characteristics.

In a first embodiment, the groove according to the invention is a ring groove in the valve seat. In particular, the ring groove is located concentrically with respect to the through hole and is resides the surface of the valve seat which is located, in the closing direction, in parallel to the valve stroke of the process valve. By means of the shape of the side surface of the groove, the flexibility of the sealing lip is maintained at the transition to the valve body. This has the advantage that, in spite of the high contact pressure, a sufficient deformability with respect to the contour of the valve body is provided and the sealing lip is robust enough to take up the high forces without being damaged. By pressing the valve body into the valve seat, the sealing edge increasingly becomes a sealing surface since the sealing lip is being deformed correspondingly,

It is particularly advantageous that the sealing edge, the edge of the valve seat facing the through hole, can be formed flattened or also rounded. Use of the sealing edge formed as a flat surface or a rounded surface in conjunction with elevated contact pressure between the valve cone and the valve seat forms a mutual contact surface. Thereby, manufacturing tolerances are compensated and an additionally elevated level of sealing is achieved.

As an alternative to orienting the ring groove in the surface arranged in the closing direction of the valve body, the ring groove can also be oriented essentially perpendicular to the valve stroke of the valve body in the through hole of the valve seat. This has the advantage that the elastic area of the sealing edge can be enlarged thereby. This again has the result of an enlargement of the stroke area within which the desired sealing effect is provided.

According to a further embodiment, the ring groove can also be in the valve body. It can extend in the direction of the valve groove as well as also perpendicular thereto.

In a particularly advantageous embodiment, the groove is inserted into the valve seat by trimming. Thereby, synergistic effects can be used in the production.

It is particularly advantageous that the angle included between the side surface of the groove located closer to the sealing edge, with the upper surface is more flat than the angle of the side surface of the groove which is more distant from the sealing edge. In particular, the side surface of the groove being closer to the sealing edge is parabolic.

By improving the leakage of a process valve by means of the groove of the invention, a highly modular structure in the design of the process valve can be maintained. For example, valve seat and valve body out of different materials and also of different geometries can be built into a valve housing. In a valve housing of given size, different valve seats can be mounted in order to realize different flow-through characteristics. By forming an inventive sealing lip, necessary reconstructions of adjacent parts are avoided. An additional seal which would be applied to the existing parts or a dividing-up of the valve seat into several parts in order to achieve a higher elasticity, would have the consequence of reconstruction.

Existing parts, the valve seat as well as the valve body, can be retrofitted according to the invention either with a groove or the respective parts can be replaced by parts being provided with a groove without further changes or reconstructions having to be done on the existing valve.

By means of an adapted formation of the sealing lip by inserting a groove with the geometry of the invention, a cost effective, robust process valve seat can be provided in a simple way.

Further advantages, features and potential applications of the present invention may be gathered from the description which follows in conjunction with the embodiments illustrated in the drawings.

Throughout the description, the claims and the drawings, those terms and associated reference signs will be used as are notable from the enclosed list of reference signs. In the drawings:

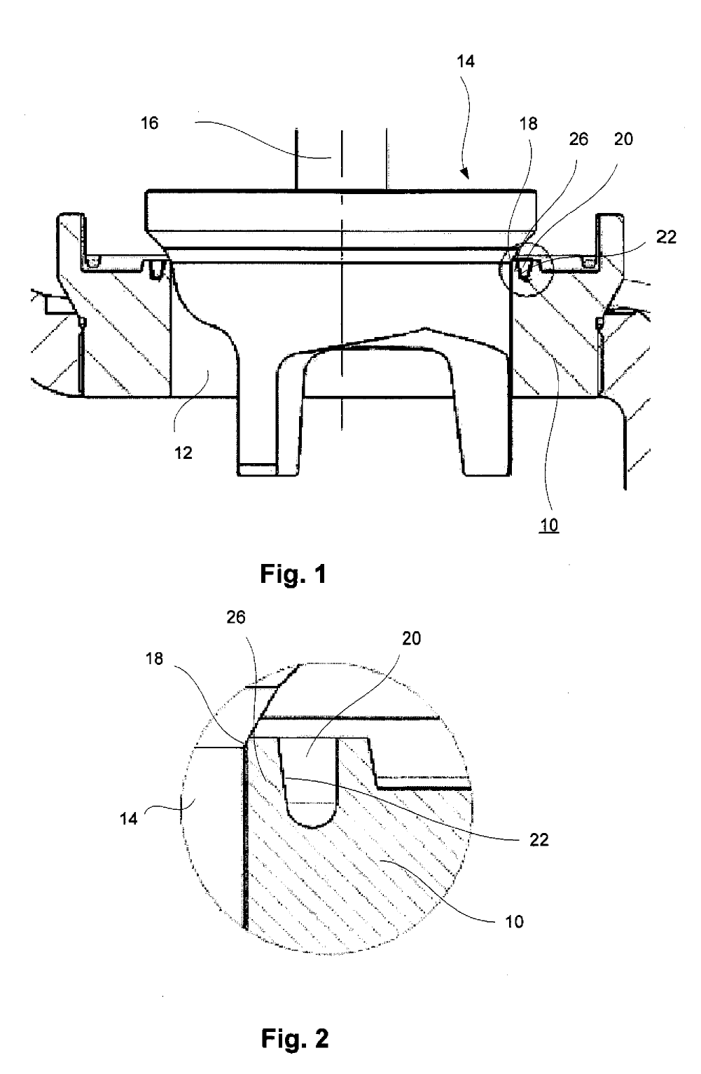

FIG. 1 is a cross section through to the process valve having a valve seat and a valve body with a sealing lip according to the invention;

FIG. 2 is an enlarged cross section of the sealing lip of FIG. 1 with a tapered side wall;

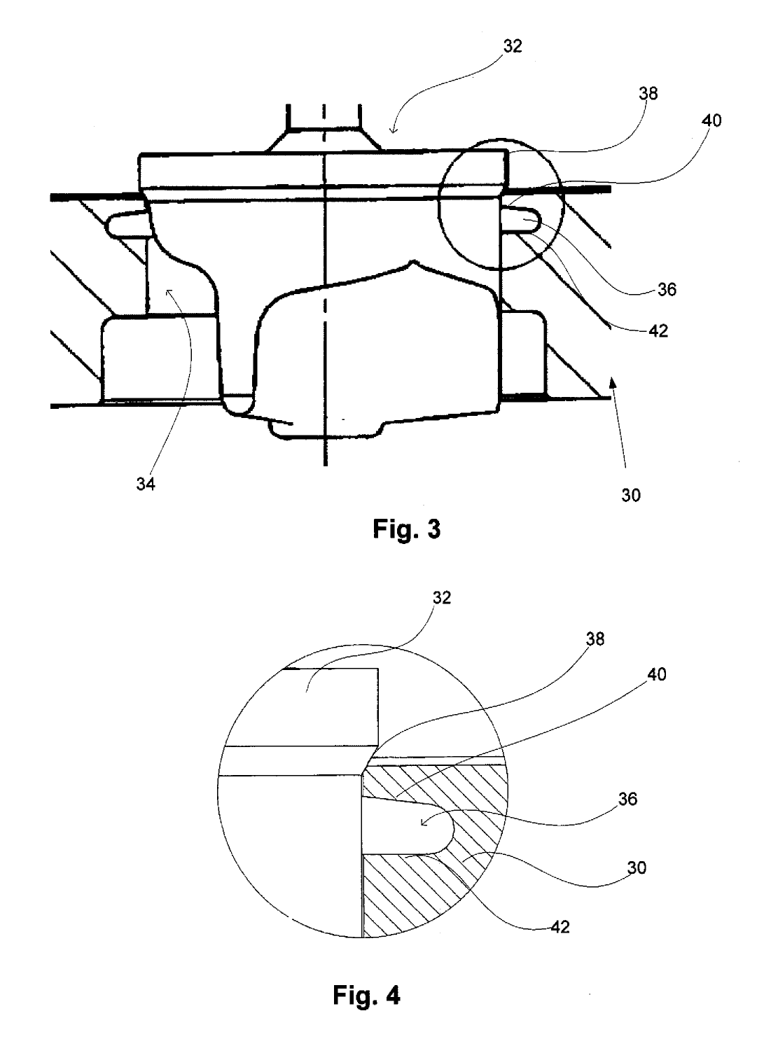

FIG. 3 is a cross section through the process valve having a valve seat and valve body with the sealing lip of the invention; and

FIG. 4 is an enlarged cross section of the sealing lip of FIG. 3 with tapered side wall,

FIG. 1 shows a valve seat 10 having a through hole 12. The through hole 12 can be closed by the valve body 14. A force is exerted upon the valve body 14 by the valve rod 16. A ring groove 20 resides in the valve seat located concentrically with through hole 12. Thereby, the sealing lip 26 is formed in between the sealing edge 18 and the ring groove 20. By means of the undercut of the ring groove, the sealing lip 26 becomes flexible and can adapt itself to the valve body 14 when it is pressed into the valve seat 10. The contact pressure of the valve body 14 exceeds 110 kN.

In order to withstand these load values, the groove 20 is formed narrowing down. For this purpose, the side wall 22 of the groove 20 is tapered whereby the tension is equally distributed across the side surface. The side surface 22 is, in section, narrowed down linearly. This enables, primarily, a simplified manufacturing and a good adaptation to the ductility of the material by adjusting the angle of the valve seat surface,

The valve seat 10 and the valve body 14 can, thereby, be completely made out of metal. This is particularly of importance with aggressive fluids because no additional soft seals are necessary for achieving the required leakage class, Aggressive fluids can dissolve the materials of soft seals and destroy the seal, Aggressive fluids can also contaminate the process fluid with the dissolved sealing materials from destroyed seals. Thereby, a leakage Class V, i.e. a leakage stream of 4 nominal liters per hour at an applied pressure of 4 bar, can be ensured.

FIG. 2 shows a large view of the valve seat 10 into which a valve body 14 is pressed. One can see here particularly well the tapered side surface 22 of the groove 20. The pressure now exerted by the valve body 14 onto the sealing edge 18 is divided up by means of the geometry of the groove 20 equally across the side surface 22 of the groove and, thereby, ensures a large stability of the sealing lip 26 and also provides a high flexibility whereby the leakage of the valve is distinctly reduced. The sealing lip 26 can compensate for tolerances in the manufacture of the valve body 14 and the valve seat 10 up to about 60 μm

FIG. 3 shows a cross section through a process valve comprising a valve seat 30 as well as a valve body 32. The fluid stream through the process valve is defined depending on the penetration depth of the valve body 32 into the valve seat 30, in case the fluid stream through the through hole 34 is to be completely prevented, the valve body 32 is completely pressed into the valve seat 30.

In order to minimize the leakage at closed-off valve, a groove 36 is inserted into the valve seat 30 perpendicular to the axis of the through hole 34.

In the closed-off state, the valve cone 32 presses onto the valve seat 30 at the sealing edge 38. The sealing edge 38 is tapered. Thereby, manufacturing tolerances can be compensated. The side surface 40 of the groove 36 is formed such that the sealing lip 44 which is formed between the sealing edge 38 and the groove 36, decreases in size with increasing depth of the groove 36. This has the advantage that the sealing lip 44 does not break also with high contact pressures of the valve body 32, since, by means of the geometry of the groove, the applied force is equally distributed across the side surface 42. Thereby, a higher stability and, in spite of that, a sufficient elasticity of the sealing lip 44 is given.

By means of the groove arranged perpendicular to the axis of the through hole 34, a sealing lip 44 is produced which comprises a very high elastic range in the direction of the closing direction of the valve. This allows, on the one hand, an enlarged stroke range within which the desired sealing is given, as well as, on the other hand, a compensation of manufacturing tolerances.

FIG. 4 shows an enlargement of the groove 36 wherein the valve body 32 just abuts to the valve seat 30. The sealing edge 38 resulting at the transition between the valve body 32 and the valve seat 30 can be seen particularly well from this drawing. Also the tapered arrangement of the sealing edge 38 is to be seen particularly well. From the enlargement, it is also apparent that the size of the sealing lip 44 continuously increases from the surface of the through hole 36 up to the deepest position of the groove 36.

### LIST OF REFERENCE SIGNS

10 valve seat

12 through hole

14 valve body

16 valve rod

18 sealing edge

20 groove

22 first tapered side surface

24 second tapered side surface

26 sealing lip

30 valve seat

32 valve body

34 through hole

36 groove

38 sealing edge

40 side surface

41 side surface

44 sealing lip

1-8. (canceled)

9. Process valve for controlling and shutting off a fluid stream, comprising:
a valve seat for receiving a movable valve body in a through hole;
said valve seat includes a circumferential groove therein;
said valve seat includes a sealing edge;
a flexible sealing lip is formed between said groove and said sealing edge, said ⁻flexible sealing lip includes a length and a thickness;
said movable valve body is pressed into and onto said sealing edge of said valve seat preventing a fluid stream through said process valve;
said groove includes a depth, said groove includes a tapered side surface, and said tapered side surface is in proximity to said sealing edge;
said tapered side surface extending increasingly away from said sealing edge as a function of depth, said thickness of said flexible seating lip increases as a function of depth of said tapered side surface of said groove of said valve seat; and,
said sealing lip being thicker as a function of depth of said groove.

10. Process valve according to claim 9, wherein said groove resides concentrically with respect to said through hole in said valve seat.

11. Process valve according to claim 9, wherein said valve seat is exclusively made of metal.

12. Process valve according to claim 9, wherein said groove is inserted in V-shape.

13. Process valve according to claim 9, wherein said side surface of said groove closer to said sealing edge is parabolic.

14. Process valve according to claim 9, wherein said groove includes a second side surface, said tapered side surface of said groove being oriented at an inclination angle, said inclination angle of said tapered side surface of said groove in proximity to said sealing edge is flatter than the inclination of said second side surface.

15. Process valve for controlling and shutting off a fluid stream as claimed in claim 9, further comprising:
said movable body includes a circumferential groove therein.

16. Process valve for controlling and shutting off a fluid stream, comprising:
a valve seat for receiving a movable valve body in a through hole;
said valve seat includes a circumferential groove therein, said groove is inserted perpendicularly to the axis of the through hole in the valve seat;
said valve seat includes a sealing edge;
a flexible sealing lip is formed between said groove and said sealing edge, said flexible sealing lip includes a length and a thickness; and,
said movable valve body is pressed into and onto said sealing edge of said valve seat preventing a fluid stream through said process valve.

17. Process valve for controlling and shutting of a fluid stream as claimed in claim 16, wherein:
said groove includes a depth, said groove includes a tapered side surface, and said tapered side surface is in proximity to said sealing edge;
said tapered side surface extending increasingly away from said sealing edge as a function of depth, said thickness of said flexible sealing lip increases as a function of depth of said tapered side surface of said groove of said valve seat; and,
said sealing lip being thicker as a function of depth of said groove.
